(19) United States
(12) Patent Application Publication
(10) Pub. No.: US 2017/0340962 A1
(43) Pub. Date: Nov. 30, 2017

(54) SYSTEM, METHOD AND COMPUTER PROGRAM PRODUCT FOR EXECUTING A CUSTOMIZED ALTERNATE REALITY SCRIPT

(71) Applicant: STITCH MEDIA ONTARIO, INC., TORONTO (CA)

(72) Inventors: EVAN JONES, LONDON (CA); DAVID FONO, TORONTO (CA)

(21) Appl. No.: 15/167,187

(22) Filed: May 27, 2016

(51) Int. Cl. A63F 13/25; A63F 13/335

(52) U.S. Cl. CPC A63F 13/25; A63F 13/335

(57) ABSTRACT

The present invention provides a system, method and computer program for a customizable player-director alternate reality game where a director customizes activities within the game based on activity data from a player.

### FIELD OF THE INVENTION

The present specification relates generally to alternate reality gaming and more specifically relates to a player-director alternate reality game where a director customizes activities within the game based on activity data from a player.

### BACKGROUND OF THE INVENTION

An alternate reality game is an interactive experience that uses a combination of a fictional world and the real world as a platform to tell a story. Alternate reality games require significant user involvement as the storyline is affected by a user's actions, namely, a user's interaction with other users, characters and storyline elements. Alternative reality games can be differentiated from traditional games, which are designed for a user to escape from reality.

With presently available alternate reality games, users experience the narrative collectively at varying rates which can interfere with their individual enjoyment as some users set a faster pace of content consumption. Furthermore, some alternate reality games exist as a single instance with less replay value once they have completed their first run. One method alternate reality games have incorporated to address this is the requirement to interact with a multimedia device, whereby the device communicates the narrative to the user and the user inputs activity data into the device. This allows instances of the alternate reality game to separate users but removes the variability that a puppet master can provide to a dynamic narrative. For educational purposes, some teachers and parents (where the game is targeted at children) may find that there is a lack of interaction and collaboration on their behalf.

Accordingly, there remains a need for improvements in the art.

### SUMMARY OF THE INVENTION

In accordance with an aspect of the invention, there is provided a system, method and computer program for a customizable player-director alternate reality game where a director customizes activities within the game based on activity data from a player.

According to an embodiment of the invention, the present invention provides a method for a customizable player-director alternate reality game comprising a host server capable of sending and receiving data over a computer communication network, a director using a director computer communication device capable of sending and receiving data over the computer communication network and a player using a player computer communication device capable of sending and receiving data over the computer communication network, the method comprising:
the host server initiating an instance of the game for the director and the player, the game comprising a script, the script comprising one or more gates, each of the one or more gates comprising at least one of: instructions for the director, instructions for the player, one or more actions to be completed by the director, one or more actions to be completed by the player, and activities, each activity comprising one or more events, and each gate further comprising a completion state, and wherein the script defines the sequence of progression through the gates, and at least one gate has its completion state indicating the completion of the game;
the host server sending, to the director computer communication device over the communication network, the initial gate to the director, and further including instructions to customize one or more of the gates for the player, based on one or more of the player's characteristics, the player characteristics comprising: age, gender, location, language, job, personality, habits, known preferences and relationship to the director;
the host server receiving, from the director computer communication device over the communication network, the customization data input by the director and customizing the one or more gates according to the customization data;
the host server sending the customized gates over the communication network to the one of the player computer communication device and the director computer communication device in accordance with the script;
the host server waiting to receive an indication of completion of the gate over the communication network from the one of the player computer communication device and director computer communication device;
the host server, upon receiving the indication of completion, sending to the other of the player computer communication device and the director computer communication device, the indication of completion and sending, according to the script, the next gate to one of the player computer communication device and the director computer communication device, according to the script; and
repeating steps until the host server receives, over the communication network, the indication of completion gate that indicates completion of the game.

Further, the method may include branches, wherein branches are a sub-type of gate, and branches comprise actions which include a decision by one of the player and the director, wherein the decision results in the selection of one gate from a set of multiple gates, such that the script is subsequently followed along a path defined by the selected gate. Still further, the branch may include instructions to the director enabling the director to modify the script such that the branch contains one or more of: a new gate in addition to existing gates, a new gate replacing an existing gate, a modified gate replacing an existing gate, and fewer gate from deletion of an existing gate, wherein the modifications are sent to the host server from the director computing device and the modifications are limited to the instance of the game.

According to a further embodiment, the present invention provides a system for a player-director alternate reality game, comprising a computer communication network; a director computer for use by a director, wherein the director computer is capable of sending and receiving data over the computer communication network; a player computer for use by a player, wherein the player computer is capable of sending and receiving data over the computer communication network; and a host server capable of sending and receiving data over the computer communication network to and from the director and player computers, wherein the host server comprises a script module for storing one or more scripts wherein the scripts each contain a list of gates to create a corresponding game instance, a game module for initiating an instance of the game for the director and the player, and an interaction module for receiving customization instructions from the director, customization gates for the player based on the customization instructions, sending gates to the director computer and the player computer, and receiving completion indications from the player computer and the director computer.

According to a further embodiment, the present invention provides a computer program product comprising a storage medium configured to store computer-readable instructions; the computer-readable instructions including instructions for,
the host server initiating an instance of the game for the director and the player, the game comprising a script, the script comprising one or more gates, each of the one or more gates comprising at least one of: instructions for the director, instructions for the player, one or more actions to be completed by the director, one or more actions to be completed by the player, and activities, each activity comprising one or more events, and each gate further comprising a completion state, and wherein the script define the sequence of progression through the gates, and at least one gate has its completion state indicating the completion of the game;
the host server sending, to the director computer communication device over the communication network, the initial gate to the director, and further including instructions to customize one or more of the gates for the player, based on one or more of the player's characteristics, the player characteristics comprising: age, gender, location, language, job, personality, habits, known preferences and relationship to the director;
the host server receiving, from the director computer communication device over the communication network, the customization data input by the director and customizing the one or more gates according to the customization data;
the host server sending the customized gates over the communication network to the one of the player computer communication device and the director computer communication device in accordance with the script;
the host server waiting to receive an indication of completion of the gate over the communication network from the one of the player computer communication device and director computer communication device;
the host server, upon receiving the indication of completion, sending to the other of the player computer communication device and the director computer communication device, the indication of completion and sending, according to the script, the next gate to one of the player computer communication device and the director computer communication device, according to the script; and
repeating steps until the host server receives, over the communication network, the indication of completion that indicates completion of the game.

Other aspects and features according to the present application will become apparent to those ordinarily skilled in the art upon review of the following description of embodiments of the invention in conjunction with the accompanying figures.

### BRIEF DESCRIPTION OF THE DRAWINGS

Reference will now be made to the accompanying drawings which show, by way of example only, embodiments of the invention, and how they may be carried into effect, and in which:

FIG. 1 is a diagram of the system components of a player-director alternate reality game according to an embodiment;

FIG. 2 is a method diagram for execution of an action node of a player-director alternate reality game according to an embodiment;

FIG. 3 is a method diagram for an action processor of a player-director alternate reality game according to an embodiment;

FIG. 4 is a method diagram for an execution controller of a player-director alternate reality according to an embodiment;

FIG. 5 is a method diagram for input sequence behavior of a player-director alternate reality game according to an embodiment;

FIG. 6 is a method diagram for an action module handler of a player-director alternate reality game according to an embodiment;

FIG. 7 is a system diagram of system components of a player-director alternate reality game according to an embodiment;

FIG. 8 is a method diagram of a player-director alternate reality game according to an embodiment; and

FIG. 9 is a screenshot of a director dashboard according to an embodiment.

Like reference numerals indicate like or corresponding elements in the drawings.

### DETAILED DESCRIPTION OF THE EMBODIMENTS

In the following, “game” shall be understood to include, without limitation, entertainment activities, educational activities and training activities.

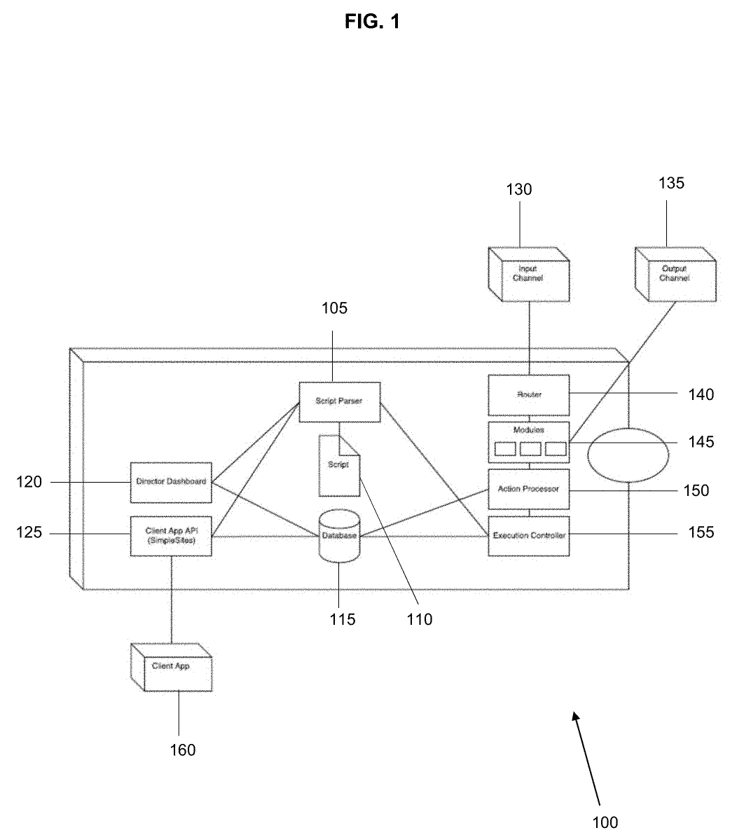

According to an embodiment as shown in FIG. 1, a system for a player-director alternate reality game 100 may include components such as a script 110, a script parser 105, a database 115, a director dashboard 120, a client application program interface (API) 125, an input channel 130, an output channel 135, a router 140, modules 145, an action processor 150, an execution controller 155 and a client application 160. The script 110 may be composed of scripting language that describes and sequences actions executed by a player and a director. The script parser 105 receives input from the script 110 to analyze embedded language. The database 115 stores data received from the director dashboard 120 and the action processor 150. The director dashboard 120 acts as an interface to allow a director to, in part, view contents of the script 110, track progress of the script 110, customize elements of the script 110, and manually trigger certain behaviors. The client API 125 implements a common sequence of activities within a customized application. The input channel 130 transmits data received from a director or a player to the router 140. The output channel 135 communicates data from modules 145 to a director or a player. The modules 145 may be input modules or output modules, wherein the input modules recognize action execution via input channel 130 and wherein the output modules render system output via output channel 135.

For reference, in the context of the present application, it is noted that the “player” may be a group or two or more players, or multiple groups or one or more players, and groups may be working cooperatively or competitively. Furthermore, groups and cooperative or competitive status may be determined by the script, the director, and/or the actions of the player.

According to an embodiment of the invention, script 110, may be written in an XML-derived language. The script 110 may describe the entirety of the sequence of actions that comprise an activity, and may be used by the system to evaluate incoming data with reference to the activity, as well as to generate output when the activity calls for it. The script 110 may be composed of a sequence of nestable elements. Each element may be a description of an action that a director or a player may perform, a grouping of related child elements, or a system directive. The description of an action may have the following components: a role that may perform the action, a unique name of the action, per-action attributes that may further define expected behavior, and metadata that may be used to describe the action in a director dashboard, such as director dashboard 120. Collectively, the nestable elements are referred to herein as gates, such that the script 110 tracks completion of each gate in reference to progress through the script by the player and the director.

Conceptually, the script 110 defines roles that are assigned to users—the director and the player. Within the script 110, roles are assigned to users according to the gate and the sequence of gates. Therefore, the multiple roles may be assigned to the same user over the course of the script 110, or the same role could be assigned to different users at different gates in the script 110, or other variations thereof.

According to an embodiment of the invention, an execution controller may parse script 110, build a programmatic model of component actions, and connect to available input/output modules. When input arrives via a module, it may be compared to expected actions at a current point in the script 110. If the input matches one of currently available defined actions, the execution controller may advance the script 110. If at any time an available action is meant to be performed by a system role, the execution controller may immediately dispatch it to the appropriate output module and may advance the script 110. The execution controller may be invoked whenever new input arrives to the system via an input module, whenever an action is performed in a director dashboard, such as director dashboard 120, and at regular system-defined intervals of time.

According to an embodiment of the invention, most input and output to and from a system may be implemented by modules, such as modules 145. The module system may be designed to simplify addition of additional modules that implement new functionality. Each module may define one or more of the following: named actions, output handlers, input handlers, and content resolution methods. The name of an action implemented in a module may become a new verb that may be used in a script, such as script 110. To implement an action, the module may provide an action handler function for the execution controller to call when attempting to complete that particular action at the point defined in the script 110. Output handlers are functions that may take arbitrary data and may render it through an output channel, such as output channel 135. While not directly used by the execution controller, action handler functions within this module and other modules may take advantage of output channels 135 for different behavior. Input handlers are functions that may take arbitrary data via a web request and may invoke the execution controller. Each handler may have a chance to process incoming data and may create a customized action record, which may then be passed into the execution controller for processing. From here, one of the modules named action handlers may use the data to implement the necessary behavior within an activity.

According to an embodiment of the invention, a director configures an activity for a player to complete. Events may be collected into a separate application that may be designed ad-hoc for each activity. Each separate application may have its own games and interfaces for an activity. Each separate application may communicate with a main system by way of an API provided by the system. The API may make the following functions available: may authorize the user and may link the user to an activity inside the system via an authorization code generated by a client application module, may authorize the director for administrative actions within the application via the director's standard login, may retrieve a feed of events generated by the client application module, may add an event setup by the director to the feed and may make the event available for the player to complete inside the application, and may mark an event as complete, wherein this form of input is handled by the client application module and may cause an execution controller to progress the activity.

An activity may be composed of a linear sequence of actions whereby each action may be performed by a director or a player. The bulk of an activity may consist of setup actions by a director interleaved with play actions by a player. The nature of the actions may vary widely and input/output module API may allow the capacity for a system to recognize new types of actions. Example actions that may already be recognized by built-in modules may include: filling in web forms, visiting webpages, making phone calls, puzzles, sub-games and physical interactions. For a type of action to be added to the system, the action may be performed with an internet-enabled object or interface.

Actions may be performed by a player or a director using objects with no capability for online communication as part of an intended part of an activity. These actions may not be technically referenced within a script, such as script 110. Alternate instructions may be given to a player that describe such an action, and may ask the player to perform the action. The player or director may confirm completion of the action within an internet-enabled interface. Confirmation of completing the action may be the action technically referenced within the script 110. Actions that must be competed for the script 110 to progress may further include an indication of completion state, which is passed to the host server.

Each action may be described by a scripting language, e.g. XML. The description of an action may contain an identifier indicating the type of the action. When the execution controller processes the script, each action in the script may be represented by a node object in memory. The node object's implementation in code may be provided by a module, which declares the connection between the action identifier in script and the node implementation in code. The behavior and functionality of the action may be provided by implementation of the node's run method.

A key type of action may be the data action provided by the data module, which many other action implementations extend. This action may collect arbitrary data from an HTTP request, store the arbitrary data, and compare the arbitrary data against validation rules defined in the script to determine if the action was successfully completed. This functionality may allow easy implementation of generic “setup” actions, as implementations for these can simply inherit functionality from the data action, and then may perform additional processing on the collected data. There are two particular action/modules that may do so in order to provide additional boilerplate actions: the choice action, that stores a single piece of collected data for examination by other actions; and the confirmation action, that checks a single piece of collected data to ensure it matches an expected value.

In addition to individual actions, scripts may include definitions of branches and threads. A thread may be a collection of actions, branches and sub-threads. The contents of a thread may consist of anything that can appear in a script, including other threads. The entirety of a script is in fact a single implicitly defined main thread. When a thread is activated by the execution controller (as the main thread is when the activity first starts), it may be processed and tracked by the execution controller as a parallel sequence of actions on all subsequent invocations. Input into the system may be handled by all active threads simultaneously, and output may be generated from all active threads simultaneously. When the final action in a thread is completed, the thread may be terminated. Branches may function like threads, but multiple branches may be defined within a single set, and only one branch within a set may become active. Additionally, branches may not be processed in parallel; when the execution controller begins processing within a branch, it may continue exclusively within that branch until the branch ends.

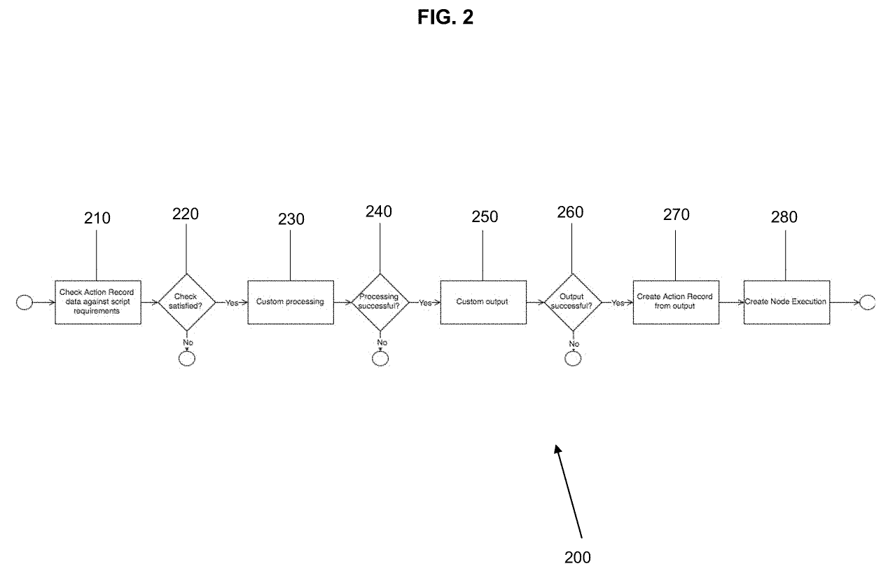

According to an embodiment as shown in FIG. 2, a method 200 for an action node's run method is shown. In general, each type of node may be integrated into a system by a module that provides a definition for the node's run method. If an execution controller, such as execution controller 155, passed an action record from an action processor, such as action processor 150, this may be also passed to the run method. The run method may then perform whatever functionality is necessary to satisfy its purpose in a script, such as script 110, which may involve one or more of the following:
a) Determining whether the provided action record matches requirements specified in the script 110, as shown in step 210. Node descriptions within the script 110 preferably specify a particular role that may be performing an associated action. The run method for such a node may first determine whether the action record was generated by a role instance corresponding to the required role, as stored in the action record and determined by data associated with an original request from an external client. If so, as shown in step 220, the run method continues; if not, as also shown in step 220, the run method terminates and returns failure. Run methods may perform additional checks similar to this using data in the action record.
b) Performing some sort of custom processing, as shown in step 230. If the processing is successful, as shown in step 240, the run method may proceed to step 250.
c) Sending data to an external output channel, such as output channel 135, as shown in step 250. A mechanism or protocol for output may be limited only by the fact that the system runs on a web server; anything that a server may communicate with may be used as such output channel 135. In this case, as shown in step 260, the method may generate a new action record, as shown in step 270, that may describe the performed output and may return it.

The method may then return one of the following:
a) A false boolean, indicating failure.
b) A true boolean, indicating success.
c) The existing action record that was passed to the method and checked as part of the method's processing, indicating success.
d) A new action record generated as a result of performed output.
e) A hash containing step (an integer) and a result, which may be one of options a), b), c) or d) listed above. This may be used in cases where node has multiple steps, i.e. more than one action may be performed to satisfy its purpose. In this case, the run method may return the step number that this execution of the method has produced. If the execution method successfully completed the final step, it may not return a step but instead may return one of options b) or c) listed above that indicate success.
   If the run method returned a value indicating success, a new node execution may be created, as shown in step 280, and stored in a database, such as database 115. This record may be associated with the current game instance, thread, and node, along with the action record and step number if returned. If the run method returned a value indicating success and did not return a step number, the current node may advance to the following node in the current thread/branch.

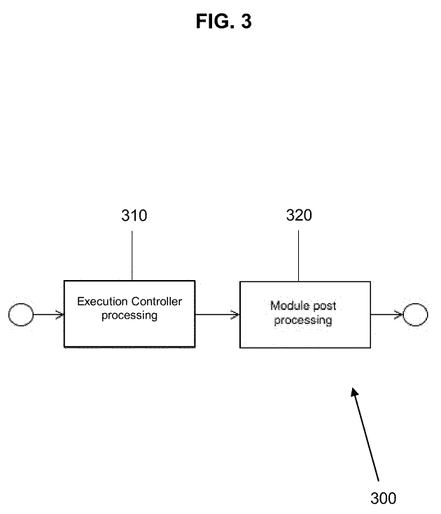

According to an embodiment as shown in FIG. 3, a method 300 for action processor 150, invokes execution controller 155, as shown in step 310, and may pass a provided action record and an associated game instance. Upon returning from the execution controller 155, the action processor 150 may then check a module that invoked the action processor 150 to determine whether the module defines a post processing method. If so, the action processor 150 invokes the post processing method and may pass the action record to the post processing method. The module may perform the post processing method, as shown in step 320, which may be entirely dependent on the functionality of the module and may have no logic or output requirements.

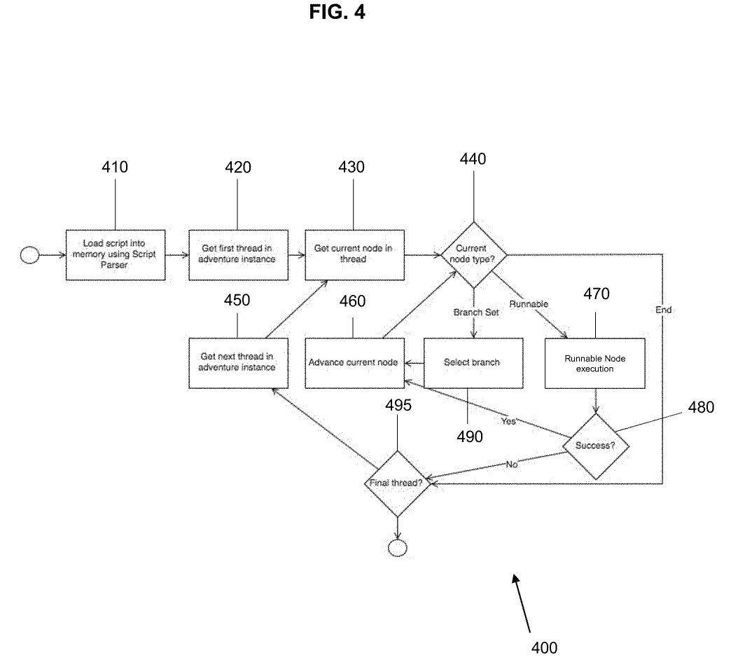

According to an embodiment as shown in FIG. 4, a method 400 for execution controller 155, may first invoke a script parser, such as script parser 105, on a given game instance's script, such as script 110, which may construct an in-memory representation of the script 110 as a series of threads containing nodes, as shown in step 410. The execution controller 155 may then step through all threads of the game instance, as shown in step 420, advancing each of them as follows:
a) A current node number for the thread is retrieved from database 115, and the associated node in the script 110 selected, as shown in step 430.
b) If the execution controller 155 was invoked directly by a router, such as router 140, in response to a skip action, and the current node has an identifier passed in an original request, the current node may immediately advance to a following node in the current thread/branch, as shown in step 440. If it is an action node, it may be executed as described in method 200 above, as shown in step 470. If it is a branch set node, the first action node may be taken from each branch and may be executed as described in method 200 above, as shown in step 490. If the run method returns success, as shown in step 480, the current node may advance to the following node in that branch, and the other branches may be subsequently ignored, as shown in step 460. If it is an end node, nothing may be done, as shown in step 495.
c) If the current node was advanced in the previous step, the process may be repeated on a new current node, as shown in step 450.

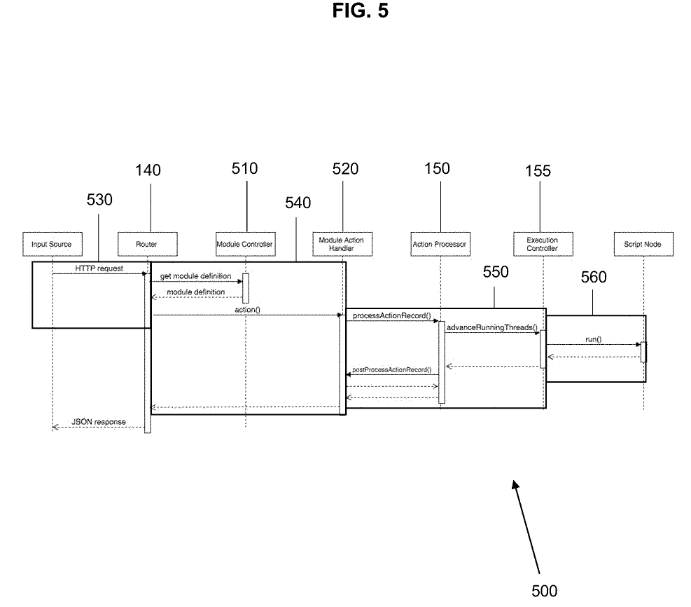

According to an embodiment as shown in FIG. 5, method 500 may include the following steps when an action is performed as part of an activity. An external client may make an HTTP request to the system. The HTTP request may specify: one of several core actions or a module name plus a module action, and arguments for the action. One of these arguments may be a game instance identification, which determines the game instance the action will be applied to. The request may then be dispatched to router 140, that checks the request, as shown in step 530. If the request is a skip action, then a node identifier may be included in the arguments. Execution controller 155, may be run with a skip parameter set to the specified node identifier, as shown in step 560. The steps described in method 400 may then be followed. If the request is an advance action, then the execution controller 155 may be run with no parameters. The steps described in method 400 may then be followed. If the request is a module action, then a module name and an action name may be included in the arguments. The router 140 may then use the module name to request a module definition from a module controller, such as module controller 510, as shown in step 540. This definition may include an action handler container with action method implementations, as shown in step 550. The router 140 may then call an action method corresponding to a provided action name. Control may then move to module implementation. Output from the action method may then be returned to the external client as an HTTP response.

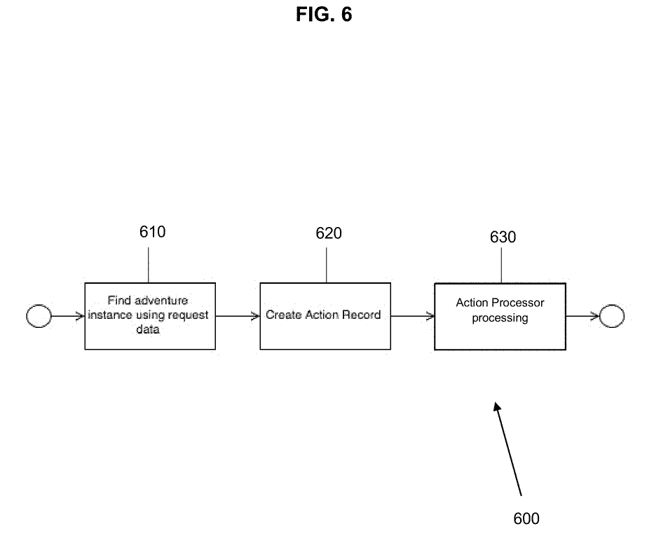

According to an embodiment as shown in FIG. 6, method 600 for module implementation may include the following steps. A module's action handler, such as module action handler 520, may pass all data received from an initial request. The action handler 520 then constructs an action record, which may include a customized data record containing relevant data from the request. To construct the action record, the module may determine what game instance an action was a part of, as shown in step 610. A strategy for this may be specific to each module; however, the most common pattern may be to compare action data to role instances defined in a database, such as database 115. For example, action data may frequently contain a unique identifier, such as an email address or a code. The module may search existing role instances for one that contains a relevant property that matches the identifier. Each role instance may be assigned to the game instance, and the game instance may be assigned to the action record, as shown in step 620. Modules may extend the data module, which may provide an authentication strategy that may also identify game instances. When another component of a system wants to make a data module action available to be performed, it may generate a nonce associated with chosen game instances, and may give it to an external client. The external client may then include this nonce part of the request made to perform the given action. When the module's action handler method is invoked, it may compare the included nonce to those stored in the database, and may retrieve the associated game instance. Alternatively, a game instance identification may be provided as part of the original request. The module may then invoke an action processor, such as action processor 150, as shown in step 630, and may pass it to the action record. Upon returning from the action processor 150, the module may generate output that is returned to the external client. The action record may have been modified during processing, and the module may check for modifications when generating output. Alternatively, no output may be generated if the external client for a given module is not expected to make use of output.

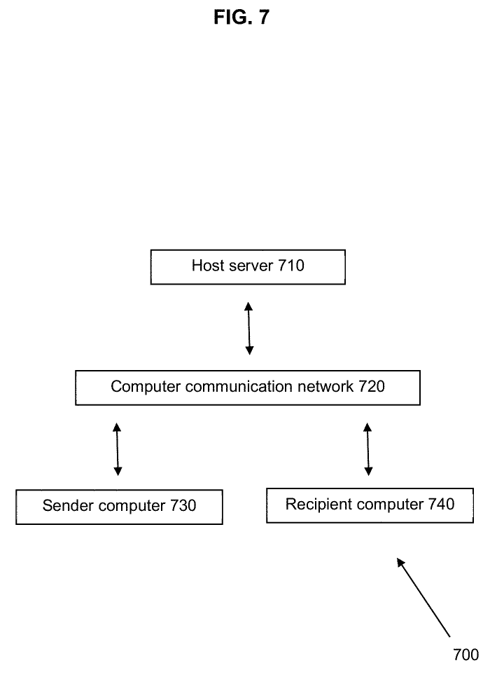

According to an embodiment as shown in FIG. 7, system 700 may include a host server 710 capable of sending and receiving data over a computer communication network 720 to and from a director computer 730 and a player computer 740. The director computer 730 may be used by a director, such as a parent or teacher. The director computer 730 may be capable of sending and receiving data over the computer communication network 720. The player computer 740 may be used by a player, such as a child or a student. The player computer 740 may be capable of sending and receiving data over the computer communication network 720.

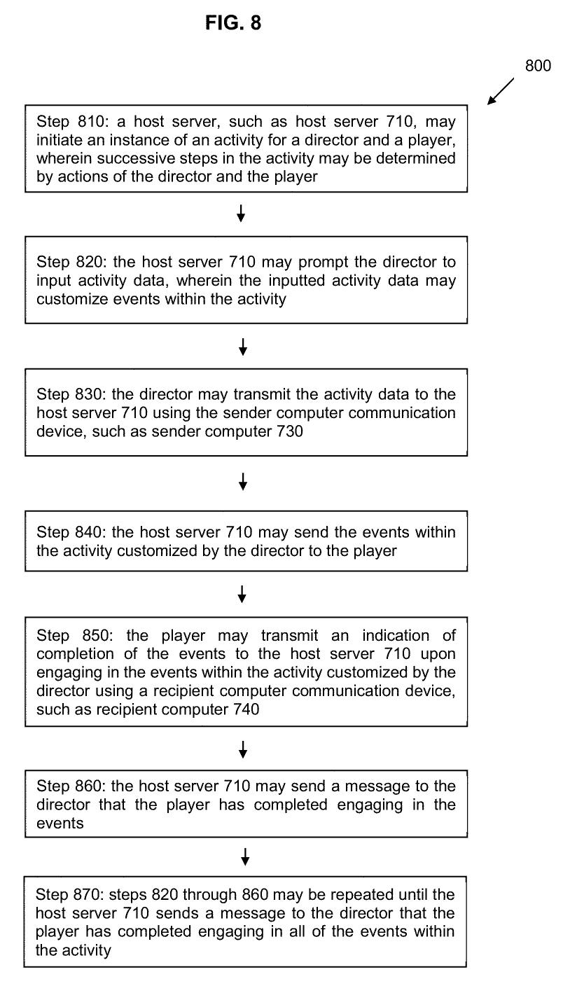

According to an embodiment as shown in FIG. 8, method 800 may comprise the following steps. In step 810, host server 710 may initiate an instance of an activity for a director and a player, wherein successive steps in the activity may be determined by actions of the director and the player. In step 820, the host server 710 may prompt the director to input activity data, wherein the inputted activity data may customize events within the activity. In step 830, the director may transmit the activity data to the host server 710 using the director computer communication device, such as director computer 730. In step 840, the host server 710 may send the events within the activity customized by the director to the player. In step 850, the player may transmit an indication of completion of the events to the host server 710 upon engaging in the events within the activity customized by the director using a player computer communication device, such as player computer 740. In step 860, the host server 710 may send a message to the director that the player has completed engaging in the events. In step 870, steps 820 through 860 may be repeated until the host server 710 sends a message to the director that the player has completed engaging in all of the events within the activity.

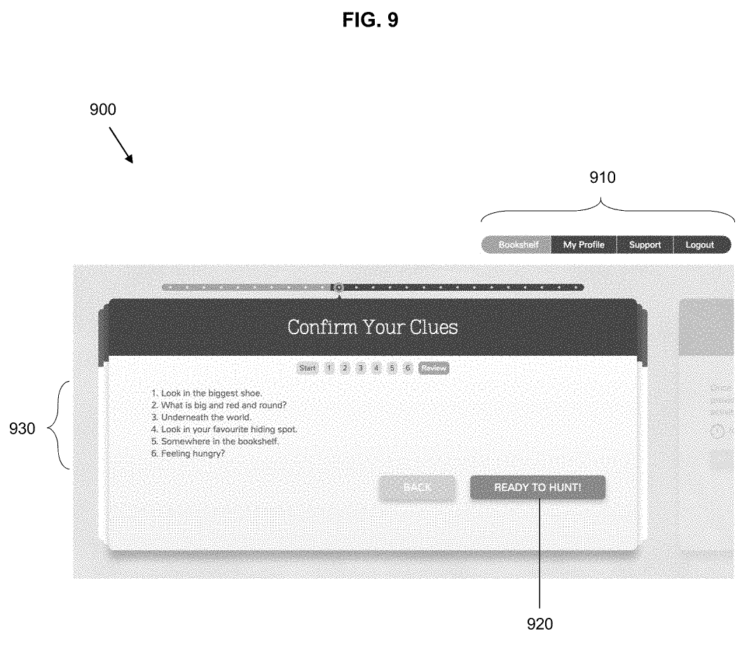

According to an embodiment as shown in FIG. 9, a director dashboard such as director dashboard 900 may provide a consistent web browser-based interface for a director to perform several key tasks such as examine the activity script, examine the progress of the activity, examine actions performed during the activity, customize the activity, and perform actions required to progress the activity. All of these tasks may be made available within a single graphical user interface. The script may be represented as a series of visual containers, each of which contains the details of a single action. Each action container may be rendered by a custom view implementation created for that particular type of action. Data passed to the view implementation may include data defined in the script, as well as action records generated during input processing and associated with the given action during processing. Further, some views may present a web form, which may pass data from the form into the system's input processing sequence depicted in FIG. 5 and use it to complete a setup/confirmation action, thus allowing the director to complete an action by interacting directly with a visual representation of it. Alternatively, the data from the web form may be passed to an independent application that uses the data to manipulate the script and customize the details of the action. Director dashboard 900 may include a top bar 910, which may comprise the following components for access by the director: bookshelf, my profile, support and logout.

### Example: Scavenger Hunt

One example of a game according to an embodiment of the invention is a scavenger hunt. In this example, the director is a parent and the player is a child, and the director hides physical clues for the player to find. The clues must be combined to solve a puzzle. For example, the clues may be stanzas of a poem which, when read in sequence, presents a riddle to which the solution is the final goal of the scavenger hunt.

The script for this activity would contain two actions. The first is the director's setup, for example represented by an action called “setup scavenger hunt”, and implemented by a scavenger hunt setup node in code. The second is the player's completion, for example represented by an action called “complete scavenger hunt”. These two actions, as well as all the events contained therein, are the gates for the scavenger hunt script.

The setup action is performed by the director using a director dashboard, such as director dashboard 900. To customize the game, the director needs to determine the location for concealing each of the clues, and the actual concealment, as each director will have a personalized layout (e.g. indoor vs. outdoor, number and layout of rooms, etc.). Based on the concealment locations, the director must then compose textual hints, such as textual hints 930, for the player to find the clues, for example, according to the age of the player (e.g. written or visual, difficulty, etc.), and submit these to the host server. Once completed, the director notifies the host server by pressing ready to hunt button 920 and the host server contacts the player to advise them that the scavenger hunt is ready to play, in accordance with the embodiments of the invention as described above.

The notification is sent to the player, for example, as a message through a messaging system received at the player's computing device, preferably a portable device, such as a tablet or phone. The player then engages in the activities (reading hints and searching for clues), and uses their computing device to indicate completion of each activity (finding a clue) and for completion of the game (inputting the final solution into the device). The host server receives these indications, and transmits completion information to the director. Thus, the host server may, according to the game script, present the player with the hints customized by the director as each clue is found, and with the final reward or notification thereof (which may also be customized) on completion of all activities.

The provision for information to pass from the player to the director further enables the director to act to modify the game in progress if necessary. For example, if the time since the last hint was provided appears unduly long, the director can provide an additional hint. Or if the player has found a clue out of order, the sequence of provided hints can be changed. The player remains unaware that the game was changed, and enjoys a seamless experience.

Furthermore, the customization enables the game to be executed for educational as well as entertainment purposes. For example, the hints (and clues) may be presented as mathematical problems, musical arrangements, spatial/geometric puzzles, or combination of different elements in accordance with achieving a desired educational objective.

### Example: Medical Communication Training

Another example of a game according to an embodiment of the invention is an online training simulation in communication for medical practitioners. In this example, the director is a program educator, the player is a medical resident and the script presents a medical diagnosis to be communicated e.g. a terminal illness. The activities are represented by information elements that must be presented and received over the course of the game by the player.

In this example, the customization by the director may include player-specific information, such as name, email address and location, which is then implemented into the script into those gates which require communications to be sent to the player. Certain scripts may permit advanced customization, such as to the content of the communications. As the player proceeds through interacting with the online simulation, the host server notifies the director of gate completion, until the simulation is terminated. At certain gates, the player responses may create branches requiring a decision from the director, which is another gate. For example, a player response, once received, could require classification into one of three categories: complete, incomplete and inappropriate, where each category, according to the script, follows a separate path of gates each starting with a request for the next player response, but structured according to the category of the previous response.

The host server also provides the ability for the director to modify the script and activity as the player progresses, for example, enabling early termination of the simulation if specific activities are met or failed. Additionally, the host server may queue player responses such that the director may monitor multiple players, for example, in a classroom setting.

The present invention may be embodied in other specific forms without departing from the spirit or essential characteristics thereof. Certain adaptations and modifications of the invention will be obvious to those skilled in the art. Therefore, the presently discussed embodiments are considered to be illustrative and not restrictive, the scope of the invention being indicated by the appended claims rather than the foregoing description and all changes which come within the meaning and range of equivalency of the claims are therefore intended to be embraced therein.

What is claimed is:

1. A method for a customizable player-director alternate reality game comprising a host server capable of sending and receiving data over a computer communication network, a director using a director computer communication device capable of sending and receiving data over the computer communication network and a player using a player computer communication device capable of sending and receiving data over the computer communication network, the method comprising:
a. the host server initiating an instance of the game for the director and the player, the game comprising a script, the script comprising one or more gates, each of the one or more gates comprising at least one of: instructions for the director, instructions for the player, one or more actions to be completed by the director, one or more actions to be completed by the player, and activities, each activity comprising one or more events, and each gate further comprising a completion state, and wherein the script defines the sequence of progression through the gates, and at least one gate has its completion state indicating the completion of the game;
b. the host server sending, to the director computer communication device over the communication network, the initial gate to the director, and further including instructions to customize one or more of the gates for the player, based on one or more of the player's characteristics, the player characteristics comprising: age, gender, location, language, job, personality, habits, known preferences and relationship to the director;
c. the host server receiving, from the director computer communication device over the communication network, the customization data input by the director and customizing the one or more gates according to the customization data;
d. the host server sending the customized gates over the communication network to the one of the player computer communication device and the director computer communication device in accordance with the script;
e. the host server waiting to receive an indication of completion of the gate over the communication network from the one of the player computer communication device and director computer communication device;
f. the host server, upon receiving the indication of completion, sending to the other of the player computer communication device and the director computer communication device, the indication of completion and sending, according to the script, the next gate to one of the player computer communication device and the director computer communication device, according to the script; and
g. repeating steps e. to f. until the host server receives, over the communication network, the indication of completion gate that indicates completion of the game.

2. The method of claim 1, further comprising branches, wherein branches are a sub-type of gate, and branches comprise actions which include a decision by one of the player and the director, wherein the decision results in the selection of one gate from a set of multiple gates, such that the script is subsequently followed along a path defined by the selected gate.

3. The method of claim 2, wherein the branch further includes instructions to the director enabling the director to modify the script such that the branch contains one or more of: a new gate in addition to existing gates, a new gate replacing an existing gate, a modified gate replacing an existing gate, and fewer gate from deletion of an existing gate, wherein the modifications are sent to the host server from the director computing device and the modifications are limited to the instance of the game.

4. The method of claim 3, wherein the modifications to the branch further include instructions to the host server that the modifications are to be made to all instances of the game with the same director.

5. The method of claim 4, wherein the modifications to the branch further include instructions to the host server that the modifications are to be made to all instances of the game with all directors.

6. The method of claim 1, when the player consists of two or more players.

7. The method of claim 6, wherein the two or more players are operating cooperatively to complete the game.

8. The method of claim 1, wherein the completion state of at least one of the gates is a real-world activity and the player computing device is used solely to indicate completion of the real-world activity.

9. The method of claim 3, wherein at least one of the modifications requires real-world action from the director.

10. A system for a player-director alternate reality game, comprising:
a computer communication network;
a director computer for use by a director, wherein the director computer is capable of sending and receiving data over the computer communication network;
a player computer for use by a player, wherein the player computer is capable of sending and receiving data over the computer communication network; and
a host server capable of sending and receiving data over the computer communication network to and from the director and player computers, wherein the host server comprises a script module for storing one or more scripts wherein the scripts each contain a list of gates to create a corresponding game instance, a game module for initiating an instance of the game for the director and the player, and an interaction module for receiving customization instructions from the director, customization gates for the player based on the customization instructions, sending gates to the director computer and the player computer, and receiving completion indications from the player computer and the director computer.

11. The system of claim 10, wherein the host server script module further comprises a branch module which enables the script module to select different gates according to the received completion indications.

12. The system of claim 11, wherein the script module is configured to permit modifications to scripts by the director as received from the director computer.

13. A computer program product comprising:
a storage medium configured to store computer-readable instructions;
the computer-readable instructions including instructions for,
a. the host server initiating an instance of the game for the director and the player, the game comprising a script, the script comprising one or more gates, each of the one or more gates comprising at least one of: instructions for the director, instructions for the player, one or more actions to be completed by the director, one or more actions to be completed by the player, and activities, each activity comprising one or more events, and each gate further comprising a completion state, and wherein the script define the sequence of progression through the gates, and at least one gate has its completion state indicating the completion of the game;
b. the host server sending, to the director computer communication device over the communication network, the initial gate to the director, and further including instructions to customize one or more of the gates for the player, based on one or more of the player's characteristics, the player characteristics comprising: age, gender, location, language, job, personality, habits, known preferences and relationship to the director;
c. the host server receiving, from the director computer communication device over the communication network, the customization data input by the director and customizing the one or more gates according to the customization data;
d. the host server sending the customized gates over the communication network to the one of the player computer communication device and the director computer communication device in accordance with the script;
e. the host server waiting to receive an indication of completion of the gate over the communication network from the one of the player computer communication device and director computer communication device;
f. the host server, upon receiving the indication of completion, sending to the other of the player computer communication device and the director computer communication device, the indication of completion and sending, according to the script, the next gate to one of the player computer communication device and the director computer communication device, according to the script; and
g. repeating steps e. to f. until the host server receives, over the communication network, the indication of completion that indicates completion of the game.

14. The method of claim 13, further comprising branches, wherein branches are a sub-type of gate, and branches comprise actions which include a decision by one of the player and the director, wherein the decision results in the selection of one gate from a set of multiple gates, such that the script is subsequently followed along a path defined by the selected gate.

15. The method of claim 14, wherein the branch further includes instructions to the director enabling the director to modify the script such that the branch contains one or more of: a new gate in addition to existing gates, a new gate replacing an existing gate, a modified gate replacing an existing gate, and fewer gate from deletion of an existing gate, wherein the modifications are sent to the host server from the director computing device and the modifications are limited to the instance of the game.

16. The method of claim 15 wherein the modifications to the branch further include instructions to the host server that the modifications are to be made to all instances of the game with the same director.

17. The method of claim 16, wherein the modifications to the branch further include instructions to the host server that the modifications are to be made to all instances of the game with all directors.

18. The method of claim 13, when the player consists of two or more real-world players.

19. The method of claim 18, wherein the real-world players are operating cooperatively to complete the game.

20. The method of claim 13, wherein the completion state of at least one of the gates is a real-world activity and the player computing device is used solely to indicate completion of the real-world activity.
